(19) United States
(12) Patent Application Publication
(10) Pub. No.: US 2025/0328947 A1
(43) Pub. Date: Oct. 23, 2025

(54) APPARATUS FOR PROVIDING GLOBAL WATER DATA SERVICE PLATFORM

(71) Applicant: Pinot Lab, Inc., Seoul (KR)

(72) Inventor: Sung Won AHN, Seoul (KR)

(21) Appl. No.: 18/974,304

(22) Filed: Dec. 9, 2024

(30) Foreign Application Priority Data
Apr. 23, 2024 (KR) 10-2024-0053930

(51) Int. Cl. G06Q 30/0601

(52) U.S. Cl. CPC G06Q 30/0631

(57) ABSTRACT

An apparatus for providing a global water data service platform can include an apparatus for providing a global water data service platform that collects detailed information on global products, selects products with detailed information matching input keywords, filters and outputs the products according to input filtering conditions, groups data included in the detailed information by associating the data with each other or providing additional information, and recommends or consults products based on the detailed information.

### BACKGROUND

### 1. Field of the Invention

An embodiment of the present disclosure relates to an apparatus for providing a global water data service platform.

### 2. Discussion of Related Art

Contents described below simply provide background information related to embodiments of the present disclosure and do not constitute the related art.

In general, a statistics-based marketing system has a structure in which a manager directly generates, compiles, and then input questionnaires to construct contents, and manually searches for and queries information input by consumers to respond to the information.

A database used for performing statistics and analysis also structurally stores and outputs information and only outputs the results of the statistics and does not respond with artificial intelligence such as a function of suggesting appropriate product vendors to individuals or consumer demand analysis and trend analysis functions. In addition, in the fashion sector, there are a lot of emotional differences and a lot of cases in situations where personal preferences, tendencies, and items are used, it is not only impossible to respond passively and respond to consumers without the manager having a large amount of information and knowledge on his own, but it also requires a lot of manpower accordingly.

Currently, with the development of Internet technology, a larger number of service providers are opening shopping malls and deploying marketing strategies to provide consumers with a huge amount of information.

Even within a single shopping mall, various vendors are selling similar products. The number of shopping malls/product vendors selling various products online or providing purchase information is increasing exponentially, and thus it takes a long time for consumers to find the product/vendor the consumers truly want. Therefore, it is not easy for consumers to select the vendor the consumers want. There is also the problem of not being able to satisfy the needs of consumers who want to receive after-sales service by specifying a specific vendor.

### SUMMARY OF THE INVENTION

The present embodiment is directed to providing an apparatus for providing a global water data service platform that collects detailed information on global products, selects products with detailed information matching input keywords, filters and outputs the products according to input filtering conditions, groups data included in the detailed information by associating the data with each other or providing additional information, and recommends or consults products based on the detailed information.

According to an aspect of the present invention, there is provided an apparatus for providing a global water data service platform, including: a keyword input unit that receives a keyword input by a user's operation or command through a terminal; a detailed information selection unit that selects product information having detailed information matching a keyword from among a plurality of pieces of product information; a product filtering unit that filters information corresponding to the keyword among the product information having the detailed information matching the keyword and then outputs final product information; a product consulting unit that generates and outputs consulting information based on the detailed information corresponding to the final product information; a product recommendation unit that selects a recommended product based on the detailed information and the consulting information; and a product promotion information generation unit that generates product promotion information based on the detailed information, the consulting information, and the recommended product.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system for providing a global water data service platform according to the present embodiment;

FIG. 2 is a diagram illustrating an apparatus for providing a global water data service platform according to the present embodiment;

FIG. 3 is a diagram for describing a method of providing a global water data service platform according to the present embodiment;

FIG. 4 is a diagram for describing a consulting method using global water data according to the present embodiment;

FIG. 5 is a diagram for describing a product recommendation method using global water data according to the present embodiment;

FIG. 6 is a diagram for explaining an artificial intelligence (AI)-based content generation method according to the present embodiment;

FIG. 7 is a diagram illustrating an example of a global water data service platform according to the present embodiment;

FIG. 8 is a conceptual diagram illustrating a method for selling a recommended product to a user according to the present embodiment; and

FIG. 9 is a conceptual diagram illustrating a method for selling a recommended product to a user according to the present embodiment.

### DETAILED DESCRIPTION OF EXEMPLARY EMBODIMENTS

Hereinafter, the present embodiment will be described in detail with reference to the attached drawings.

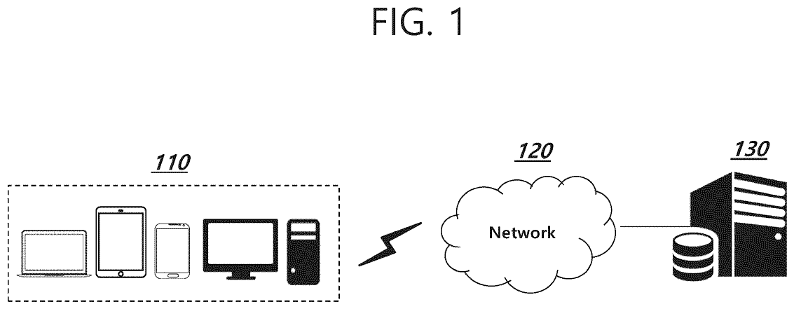

FIG. 1 is a diagram illustrating a system for providing a global water data service platform according to the present embodiment.

The system for providing a global water data service platform according to the present embodiment includes a terminal 110, a network 120, and an apparatus 130 for providing a global water data service platform. The components included in the system for providing a global water data service platform are not necessarily limited thereto.

The terminal 110 is an electronic device that performs audio or data communication via the network 120 according to a user's key operation.

The terminal 110 has a memory for storing a program or protocol for communication with the apparatus 130 for providing a global water data service platform via the network 120, a microprocessor for executing the program and performing calculations and controls, etc.

The terminal 110 may be an electronic device such as a smart phone, a tablet, a laptop, a personal computer (PC), a personal digital assistant (PDA), a game console, a portable multimedia player (PMP), a wireless communication terminal, a media player, etc.

The terminal 110 is a diverse device that includes a communication device such as a communication modem for performing communication with various devices or wired/wireless networks, a memory for storing various programs and data, a microprocessor for executing programs and performing calculations and controls, etc. According to at least one embodiment, the memory may be a computer-readable recording/storage medium such as a random access memory (RAM), a read only memory (ROM), a flash memory, an optical disk, a magnetic disk, a solid state disk (SSD), etc. According to at least an embodiment, the microprocessor may be programmed to selectively perform one or more of the operations and functions described in the specification. According to at least an embodiment, the microprocessor may be implemented entirely or in part as hardware such as an application specific integrated circuit (ASIC) of a specific configuration.

The network 120 is a network that may transmit and receive data using various wired and wireless communication technologies such as the Internet, the intranet, a mobile communication network, and a satellite communication network using the Internet protocol.

The apparatus 130 for providing a global water data service platform includes a hardware module identical to a typical web server, a web application proxy (WAP) server, or a network server.

The apparatus 130 for providing a global water data service platform generally communicates with an unspecified number of clients or other servers via an open computer network such as the Internet.

The apparatus 130 for providing a global water data service platform is a computer system or computer software (web server program) that derives and provides work results corresponding to work execution requests from clients or other web servers.

The apparatus 130 for providing a global water data service platform includes a series of application programs operating on the web server or various databases built within the device, in addition to the above-described web server program.

The apparatus 130 for providing a global water data service platform according to the present embodiment extracts detailed information on products when receiving keywords from the terminal 110. The apparatus 130 for providing a global water data service platform selects detailed information (production country information, production site information, water source information, manufacturer information, ingredient information, and storytelling information) matching the keywords. The apparatus 130 for providing a global water data service platform filters and outputs products having the detailed information matching the keywords.

Here, when the product is water or alcohol, the detailed information may additionally include tasting notes and features of water. The storytelling information may be generated using generative artificial intelligence (generative AI). The tasting notes store information received from a professor or water sommelier. Similar water is recommended based on the features of water (water taste, mineral components, and water weight).

When filtering is requested by country, the apparatus 130 for providing a global water data service platform outputs bottled water industry, the features of water, and products corresponding to the country.

The apparatus 130 for providing a global water data service platform may output data (production country information, production site information, water source information, manufacturer information, storytelling information, and ingredient information) included in the detailed information by associating the data with each other and grouping the data (by country, by region) or by additionally filtering the data (by removing unnecessary information).

The apparatus 130 for providing a global water data service platform provides detailed information on products to business-to-business (B2B) companies. The apparatus 130 for providing a global water data service platform compares detailed information on products using a comparison function and outputs the detailed information on one screen.

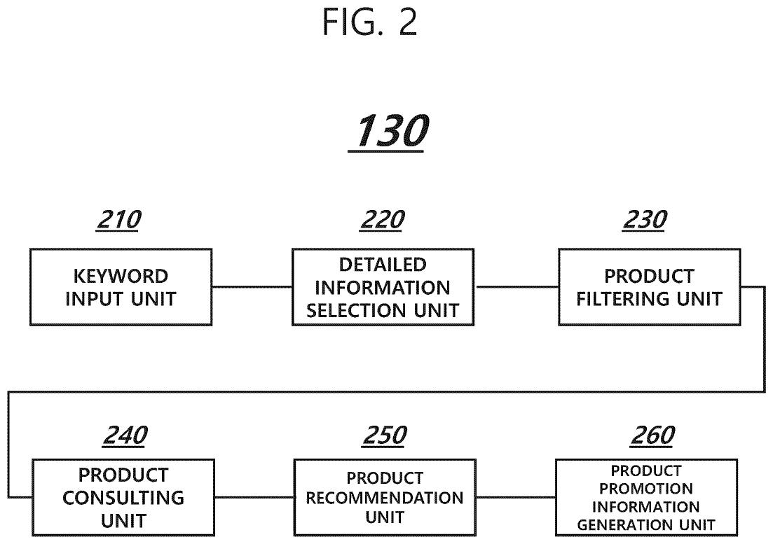

FIG. 2 is a diagram illustrating an apparatus for providing a global water data service platform according to the present embodiment.

The apparatus 130 for providing a global water data service platform according to the present embodiment includes a keyword input unit 210, a detailed information selection unit 220, a product filtering unit 230, a product consulting unit 240, a product recommendation unit 250, and a product promotion information generation unit 260. The components included in the apparatus 130 for providing a global water data service platform are not necessarily limited thereto.

Each component included in the apparatus 130 for providing a global water data service platform is connected to a communication path connecting software modules or hardware modules inside the device and may operate organically with each other. These components communicate using one or more communication buses or signal lines.

Each component of the apparatus 130 for providing a global water data service platform illustrated in FIG. 2 means a unit that processes at least one function or operation, and may be implemented as a software module, a hardware module, or a combination of the software and hardware.

The keyword input unit 210 receives keywords from the terminal 110 by a user's operation or command.

The detailed information selection unit 220 selects product information having the detailed information matching the keywords among a plurality of pieces of product information. The detailed information selection unit 220 selects one or more of the production country information, the production site information, the water source information, the manufacturer information, the ingredient information, and the storytelling information included in the detailed information matching the keywords.

The product filtering unit 230 filters the information corresponding to the keywords among the product information having the detailed information matching the keywords and then outputs the final product information.

The product consulting unit 240 generates and outputs consulting information based on the detailed information corresponding to the final product information. The product consulting unit 240 extracts the storytelling information included in the detailed information and then generates the consulting information based on the storytelling information. The product consulting unit 240 extracts product-specific special features based on the detailed information and allows the extracted product-specific special features to be included in the consulting information.

The product recommendation unit 250 selects recommended products based on the detailed information and the consulting information. The product recommendation unit 250 recommends products in response to the keywords based on values that reflect weights by category for the keywords.

The product promotion information generation unit 260 generates product promotion information based on the detailed information, the consulting information, and the recommended products.

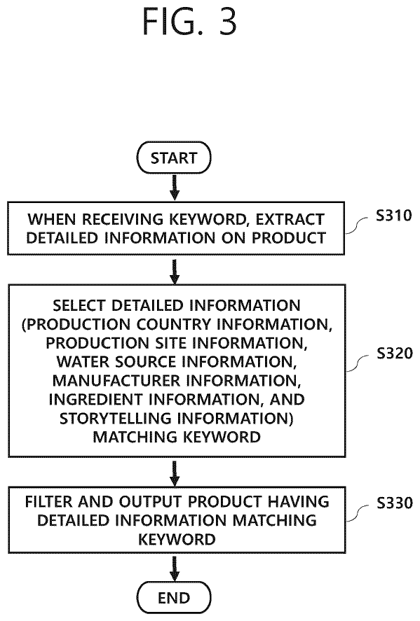

FIG. 3 is a diagram for describing a method of providing a global water data service platform according to the present embodiment.

When receiving the keywords, the apparatus 130 for providing a global water data service platform extracts detailed information on products (S310).

The apparatus 130 for providing a global water data service platform selects detailed information (production country information, production site information, water source information, manufacturer information, ingredient information, and storytelling information) matching the keywords (S320).

The apparatus 130 for providing a global water data service platform filters and outputs products having the detailed information matching the keywords (S330).

Although operations S310 to S330 are described as being executed sequentially in FIG. 3, the present disclosure is not necessarily limited thereto.

In other words, since it is possible to change and execute the operations described in FIG. 3 or to execute one or more operations in parallel, FIG. 3 is not limited to a chronological order.

As described above, the method of providing a global water data service platform according to the present embodiment described in FIG. 3 may be implemented as a program and recorded on a computer-readable recording medium. The computer-readable recording medium on which a program for implementing the method of providing a global water data service platform according to the present embodiment is recorded includes all types of recording devices that store data that may be read by a computer system.

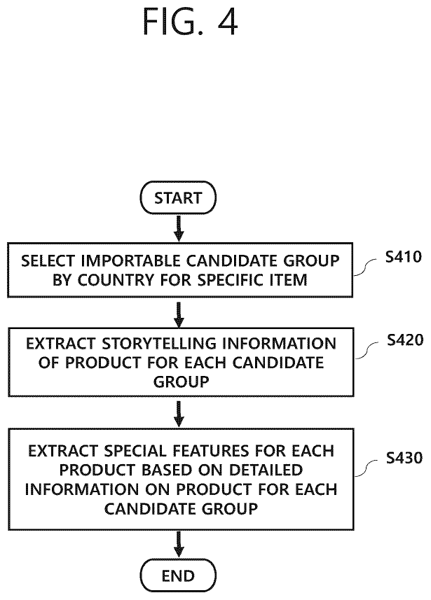

FIG. 4 is a diagram for describing a consulting method using global water data according to the present embodiment.

The apparatus 130 for providing a global water data service platform selects an importable candidate group for a specific item (S410).

The apparatus 130 for providing a global water data service platform extracts storytelling information included in detailed information on products for each candidate group and generates consulting information (S420).

The apparatus 130 for providing a global water data service platform extracts product-specific special features based on the detailed information on the products for each candidate group and allows the extracted product-specific special features to be included in the consulting information (S430).

The apparatus 130 for providing a global water data service platform finds products that are not traded between countries (products that have not yet entered the country from overseas) and provides consulting leading to sales.

Although operations S410 to S430 are described as being executed sequentially in FIG. 4, the present disclosure is not necessarily limited thereto. In other words, since it is possible to change and execute the operations described in FIG. 4 or to execute one or more operations in parallel, FIG. 4 is not limited to a chronological order.

As described above, the consulting method using global water data according to the present embodiment described in FIG. 4 may be implemented as a program and recorded on the computer-readable recording medium. The computer-readable recording medium on which the program for implementing the consulting method using global water data according to the present embodiment is recorded includes all types of recording devices in which data that may be read by the computer system is stored.

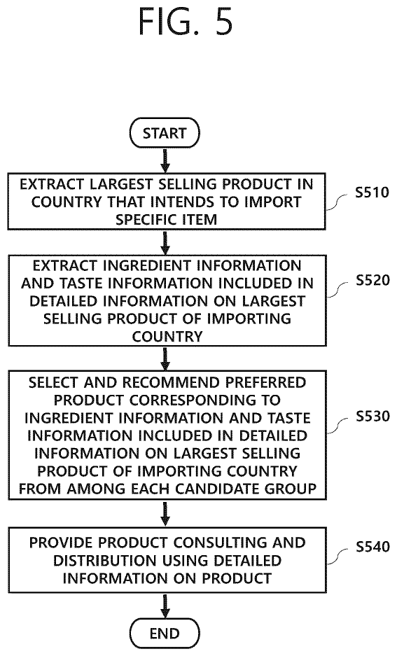

FIG. 5 is a diagram for describing a product recommendation method using global water data according to the present embodiment.

The apparatus 130 for providing a global water data service platform extracts largest selling products in the country from which a specific item is to be imported (S510).

The apparatus 130 for providing a global water data service platform extracts ingredient information and taste information included in detailed information on largest selling products in the importing country (S520).

The apparatus 130 for providing a global water data service platform selects and recommends preferred products corresponding to the ingredient information and the taste information included in the detailed information on the largest selling products in the importing country among each candidate group (S530).

The apparatus 130 for providing a global water data service platform provides product consulting and distribution using the detailed information on the products (S540).

Although operations S510 to S540 are described as being executed sequentially in FIG. 5, the present disclosure is not necessarily limited thereto. In other words, since it is possible to change and execute the operations described in FIG. 5 or to execute one or more operations in parallel, FIG. 5 is not limited to a chronological order.

As described above, the product recommendation method using global water data according to the present embodiment described in FIG. 5 may be implemented as a program and recorded on the computer-readable recording medium. The computer-readable recording medium on which the program for implementing the product recommendation method using global water data according to the present embodiment is recorded includes all types of recording devices in which data that may be read by the computer system is stored.

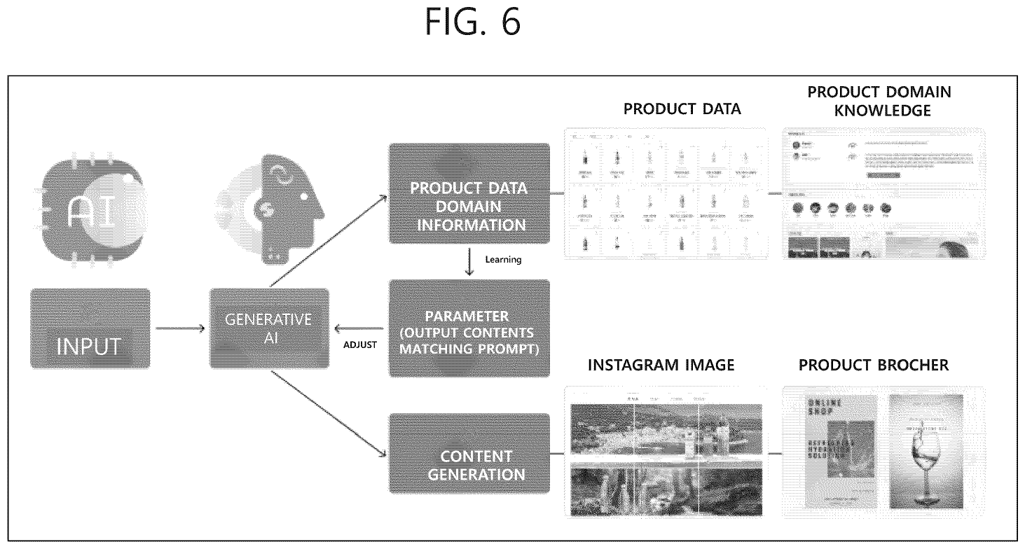

FIG. 6 is a diagram for explaining an AI-based content generation method according to the present embodiment.

The apparatus 130 for providing a global water data service platform generates some of the detailed information on the products using the generative AI.

The apparatus 130 for providing a global water data service platform generates the detailed information on the products by extracting keywords from texts of product information and then synthesizing the generated detailed information with product images (e.g., product images extracted from Instagram).

The apparatus 130 for providing a global water data service platform extracts marketing points from the collected detailed information on the products.

The apparatus 130 for providing a global water data service platform may extract marketing points by generating promotional text (clean water from a specific region) in connection with regional information included in the detailed information.

The apparatus 130 for providing a global water data service platform collects and analyzes detailed information on products to extract marketing points, identifies product features, functions, performance, and prices, and extracts differentiated elements through comparative analysis with competing products.

The apparatus 130 for providing a global water data service platform identifies customer groups with a high probability of purchasing products to extract the marketing points and analyzes their needs and preferences. The apparatus 130 for providing a global water data service platform collects and analyzes demographic information such as age, sex, income, and occupation of customers as well as behavioral information such as purchase patterns and preferred brands.

The apparatus 130 for providing a global water data service platform sets marketing goals based on the analysis results to extract the marketing points. For example, the apparatus 130 for providing a global water data service platform sets a goal of increasing product awareness or increasing product sales.

The apparatus 130 for providing a global water data service platform derives the marketing points based on the product analysis results and the customer analysis results. The apparatus 130 for providing a global water data service platform selects the marketing points based on the differentiated elements of the products or elements that match the needs and preferences of customers.

The apparatus 130 for providing a global water data service platform determines marketing channels, advertising texts, designs, etc., in the process of establishing a marketing strategy based on the marketing points.

The apparatus 130 for providing a global water data service platform executes advertisements, conducts events, and collects and improves feedback through communication with customers in the process of executing the established marketing strategy.

The apparatus 130 for providing a global water data service platform measures sales, awareness, customer satisfaction, etc., and evaluates the effectiveness of the marketing strategy when analyzing marketing performance after the marketing execution.

The apparatus 130 for providing a global water data service platform may take actions such as modifying the marketing points or changing the marketing channels when improving the marketing strategy based on the results of analyzing the marketing performance.

The apparatus 130 for providing a global water data service platform inputs product data and product domain knowledge to generative AI based on product data domain information. The apparatus 130 for providing a global water data service platform trains the product data and product domain knowledge using the generative AI to generate parameters that match a prompt. The apparatus 130 for providing a global water data service platform may extract product images from Instagram or product brochures using the generative AI and generate advertising images by synthesizing promotional text generated based on the parameters that match the prompt.

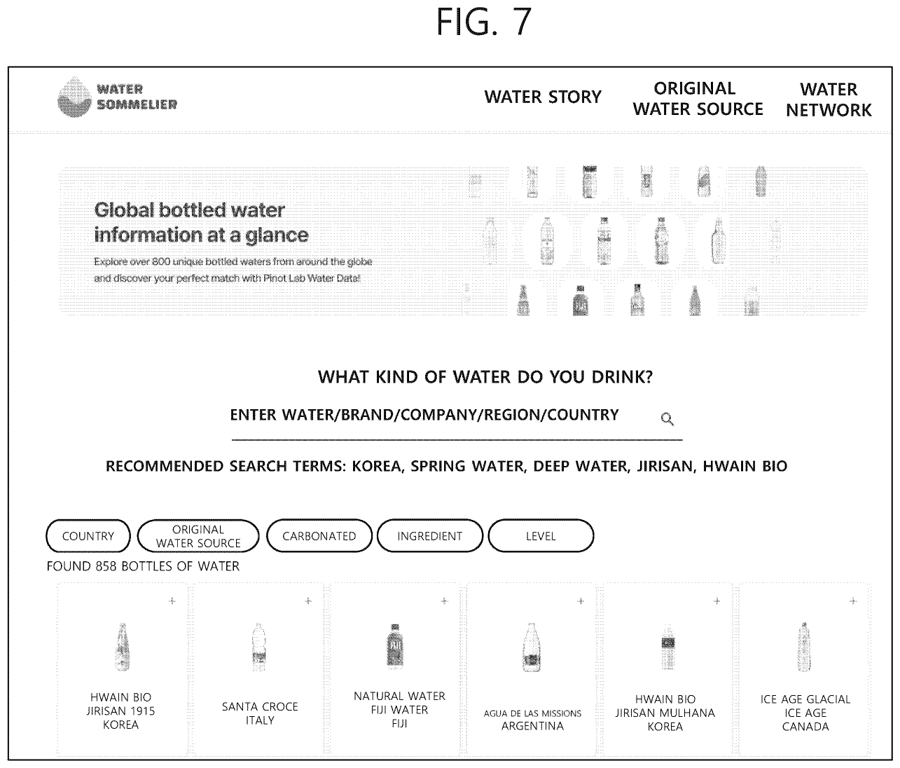

FIG. 7 is a diagram illustrating an example of the global water data service platform according to the present embodiment.

The apparatus 130 for providing a global water data service platform recommends a specific product based on the detailed information on products collected in response to an input keyword.

The apparatus 130 for providing a global water data service platform reflects weights in the same elements as ingredients and taste characteristics of products already sold in each country of sale based on the ingredients and taste characteristics in response to the input keyword.

The apparatus 130 for providing a global water data service platform recommends products in response to the input keyword by reflecting weights by category (by age, sex, and region).

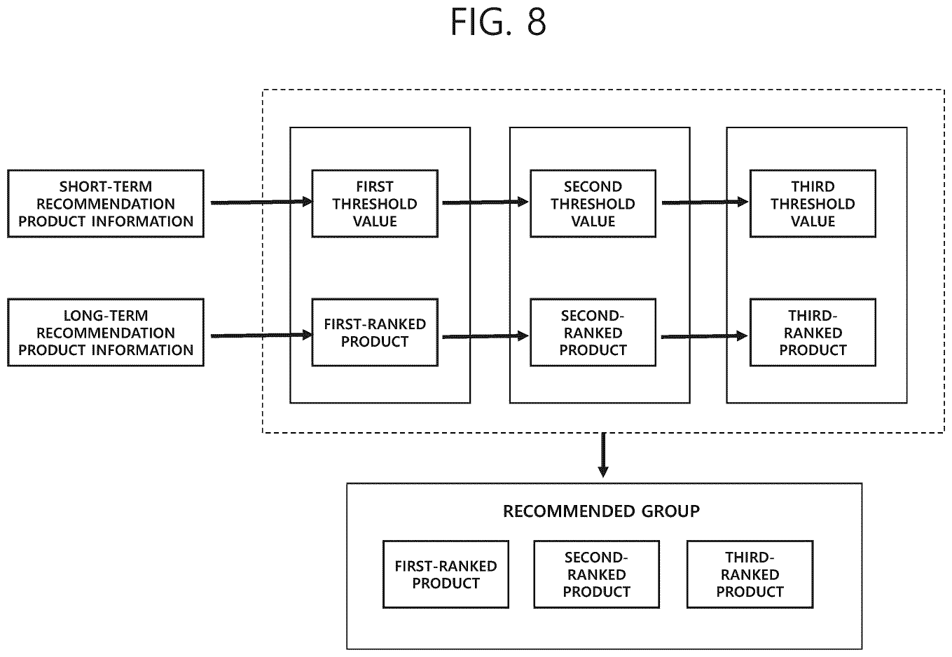

FIG. 8 is a conceptual diagram illustrating a method for selling a recommended product to a user according to the present embodiment.

In FIG. 8, the apparatus 130 for providing a global water data service platform explains an operation of recommending a product to a user based on user's personal information.

Referring to FIG. 8, the apparatus 130 for providing a global water data service platform may classify the user's personal information into short-term recommendation personal information and long-term recommendation personal information for product recommendation. The apparatus 130 for providing a global water data service platform classifies the short-term recommendation personal information as the information for recommending products to the users in the short term. The apparatus 130 for providing a global water data service platform classifies the long-term recommendation personal information as the information for recommending products to the users in the long term.

For example, the apparatus 130 for providing a global water data service platform may be used to recommend products in the short term as the short-term recommendation personal information when stress temporarily increases due to a specific event and may be used to recommend products in the long term as the long-term recommendation personal information when constant management is required due to a specific chronic disease.

The apparatus 130 for providing a global water data service platform of the apparatus 130 for providing a global water data service platform may adaptively recommend products based on at least one of the short-term recommendation personal information and the long-term recommendation personal information.

The apparatus 130 for providing a global water data service platform may first extract common recommendation elements (e.g., specific component A) based on the short-term recommendation personal information and the long-term recommendation personal information for product recommendation. Thereafter, the apparatus 130 for providing a global water data service platform may determine a product that includes a common recommendation element greater than or equal to a first threshold value as a first-ranked recommended product. The apparatus 130 for providing a global water data service platform determines the recommendation elements that are determined to be necessary based on both the short-term recommendation personal information and the long-term recommendation personal information as the common recommendation elements.

The apparatus 130 for providing a global water data service platform may determine the first threshold value by considering the status of the user included in the short-term recommendation personal information and the long-term recommendation personal information. For example, the apparatus 130 for providing a global water data service platform may determine the threshold value in such a way that when the stress index is relatively high, the first threshold value of the recommendation element necessary for relieving the stress becomes relatively high.

Thereafter, the apparatus 130 for providing a global water data service platform may determine the recommended products to be recommended in the second and third rankings based on the individual recommendation elements excluding the common recommendation elements for each of the short-term recommendation personal information and the long-term recommendation personal information. The apparatus 130 for providing a global water data service platform determines the recommendation elements individually required only for the short-term recommendation personal information or the long-term recommendation personal information as individual recommendation elements.

The apparatus 130 for providing a global water data service platform may preferentially select a product that commonly includes an individual recommendation element (e.g., a specific component B) that is greater than or equal to the second threshold value as a second-ranked recommended product.

Thereafter, the apparatus 130 for providing a global water data service platform may determine a product that does not commonly include an individual recommendation element (e.g., a specific component B) but has characteristics of an individual recommendation element that is greater than or equal to the third threshold value as a third-ranked recommended product.

The apparatus 130 for providing a global water data service platform may set the first threshold value, the second threshold value, and the third threshold value as excess values based on default values of the recommendation elements. For example, when a default value of a specific component A included in the product is x, the apparatus 130 for providing a global water data service platform may set the first threshold value, the second threshold value, and the third threshold value by considering the excess capacity of the specific component A based on x.

In the present disclosure, the apparatus 130 for providing a global water data service platform may set the threshold values to increase in the order of the first threshold value, the second threshold value, and the third threshold value. By using the method, the apparatus 130 for providing a global water data service platform recommends products based on the long-term recommendation personal information but may perform product recommendations that sufficiently consider the short-term recommendation personal information. That is, when the apparatus 130 for providing a global water data service platform is set in an increasing manner in the order of the first threshold, the second threshold, and the third threshold, the apparatus 130 for providing a global water data service platform determines products with product characteristics that strongly include individual recommendation elements as the second and third rankings and provides the determined products to users, thereby providing the recommendation results that sufficiently reflect the short-term recommendation personal information.

According to an embodiment of the present disclosure, the apparatus 130 for providing a global water data service platform may set the first threshold value to be relatively higher as the length of the recommendation period corresponding to the short-term recommendation personal information gets shorter, so the product recommendations corresponding to the short-term recommendation personal information may be made. That is, the apparatus 130 for providing a global water data service platform may provide a product that includes the individual recommendation element as the recommendation target even if it does not satisfy the common recommendation element by considering the individual recommendation element more than the common recommendation element. That is, the apparatus 130 for providing a global water data service platform can may the characteristics of the recommended product to better match the short-term recommendation personal information through the change in the threshold value as above when the short-term product recommendation is required.

In the present disclosure, when providing the first-ranked recommended product, the second-ranked recommended product, and the third-ranked recommended product, the apparatus 130 for providing a global water data service platform may set the first-ranked recommended product, the second-ranked recommended product, and the third-ranked recommended product as the recommendation group through one packaging and recommend purchase to users. The apparatus 130 for providing a global water data service platform may set purchase ratios of the first-ranked recommended product, the second-ranked recommended product, and the third-ranked recommended product based on the short-term recommendation personal information and the long-term recommendation personal information, and group the first-ranked recommended product, the second-ranked recommended product, and the third-ranked recommended product and transmit the grouped first-ranked recommended product, second-ranked recommended product, and third-ranked recommended product to the terminal 110 together with the recommendation information.

The apparatus 130 for providing a global water data service platform may determine the recommendation ratios of the first-ranked recommended product, the second-ranked recommended product, and the third-ranked recommended product by considering the recommendation period of the short-term recommendation personal information. The apparatus 130 for providing a global water data service platform may set the purchase ratios of the second-ranked recommended product and the third-ranked recommended product relatively higher when the length of the recommendation period corresponding to the short-term recommendation personal information is relatively shorter.

The apparatus 130 for providing a global water data service platform may set the purchase ratios of the first-ranked recommended product and the second-ranked recommended product by considering the importance of the short-term recommendation personal information and the long-term recommendation personal information. For example, the apparatus 130 for providing a global water data service platform may set the purchase ratios of the first-ranked recommended product, the second-ranked recommended product, and the third-ranked recommended product by additionally considering the corresponding elements by setting the short-term recommendation personal information or the long-term recommendation personal information due to a specific disease to be the relatively high importance.

According to an embodiment of the present disclosure, the apparatus 130 for providing a global water data service platform may differently set purchase cycles for the first-ranked recommended product, the second-ranked recommended product, and the third-ranked recommended product included in the recommendation group by considering the short-term recommendation personal information in units of time For example, the apparatus 130 for providing a global water data service platform may set the purchase ratio based on one day to schedule purchases of different recommended products within one day, or may set a purchase ratio based on one week/one month to schedule purchases of different recommended products within one week/one month. The apparatus 130 for providing a global water data service platform may set a purchase cycle based on the short-term recommendation personal information by considering the cycle required by the user for the recommended elements corresponding to the short-term recommendation personal information.

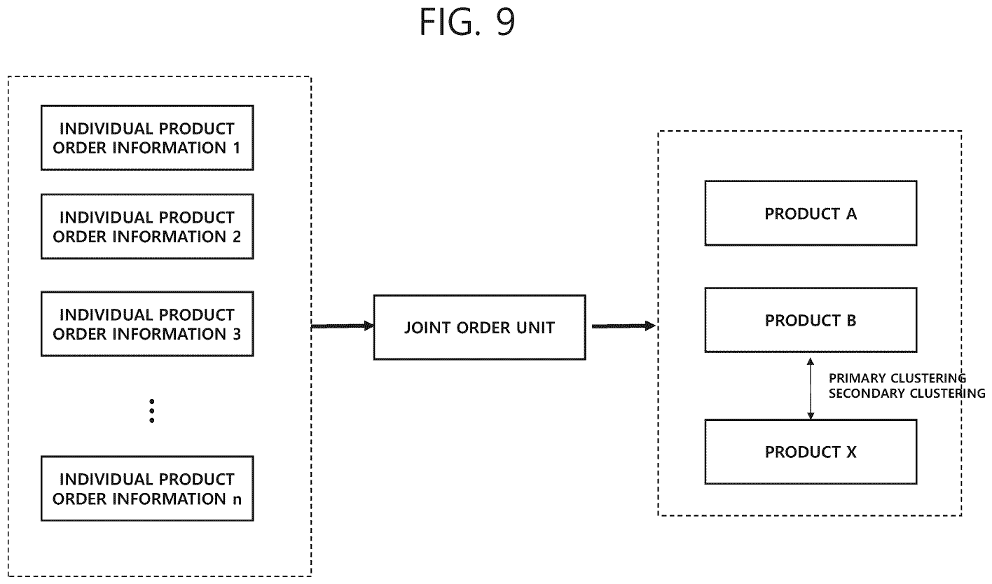

FIG. 9 is a conceptual diagram illustrating a method for selling a recommended product to a user according to the present embodiment.

FIG. 9 describes a method for an apparatus 130 for providing a global water data service platform to sell a recommended product to a user. In particular, the apparatus 130 for providing a global water data service platform specifically describes a method for distributing a plurality of different products without inventory.

Referring to FIG. 9, when the product purchase unit is not large in quantity, the distribution cost for import may be relatively large. Therefore, the apparatus 130 for providing a global water data service platform may supply products to multiple users more cheaply by combining product orders of multiple users and purchasing the combined products in order units that reduce distribution costs and also allow users to purchase various products in small quantities.

The apparatus 130 for providing a global water data service platform according to the present embodiment combines individual product order data of multiple users in specific cycle units and performs orders and deliveries for products manufactured domestically/overseas as a joint order unit. Here, information on individual product orders of users includes product type information, product order quantity information, etc.

In the case of a specific product (e.g., product A), an order may be placed when the product order quantity ordered within the set cycle exceeds a first threshold order quantity set for product A. Such a product may be expressed as a term of a product that satisfies the minimum order quantity.

The apparatus 130 for providing a global water data service platform may set a threshold order quantity differently for each type of product in consideration of distribution costs.

Conversely, for a specific product (e.g., product B), the product order quantity ordered within the set cycle may not exceed the second threshold order quantity set for product B. Such a product may be expressed as a term of a product that satisfies the minimum order quantity.

First, the apparatus 130 for providing a global water data service platform may determine whether an alternative product order is available among the individual product order data that orders the product B, and determine the product order quantity for another Product X that can replace the product B. When a product order quantity of product X that can replace the product B exceeds a third threshold order quantity set for the product X, the apparatus 130 for providing a global water data service platform may additionally order and provide the product X instead of the product B for the individual product order.

Secondarily, when the product order quantity of the product X does not exceed the third threshold order quantity of the product X, the apparatus 130 for providing a global water data service platform may combine the product order quantities of the products with the smaller product order quantity and the relatively larger product order quantity among the product B and the product X that can replace the product B and provide the combined product. For example, when the product order quantity of the product B is larger than that of the product X, the apparatus 130 for providing a global water data service platform may adjust the product X to be converted to the product B based on the product B, thereby increasing the product order quantity of the product B to exceed the second threshold order quantity.

In the present disclosure, the apparatus 130 for providing a global water data service platform may determine whether products are interchangeable based on product characteristic information. The apparatus 130 for providing a global water data service platform may vectorize the product characteristic information into multiple dimensions, and perform primary clustering based on the product characteristic information vectorized into the multiple dimensions. The apparatus 130 for providing a global water data service platform may perform the primary clustering based on quantization or scaling by considering weights that consider importance among the product characteristic information when performing the primary clustering. For example, the apparatus 130 for providing a global water data service platform may perform the primary clustering considering importance by differently setting weights for a first specific component and weights for a second specific component, and quantizing or scaling at wider intervals as importance increases. The apparatus 130 for providing a global water data service platform may set importance relatively higher for characteristic information that changes the product characteristics relatively larger.

Next, the apparatus 130 for providing a global water data service platform performs secondary clustering by adjusting the clustering result based on the user feedback data. The apparatus 130 for providing a global water data service platform adjusts a distance between vector values corresponding to a plurality of products based on user feedback data for alternative order data by the user and products with the same user feedback. The apparatus 130 for providing a global water data service platform extracts user feedback similarity, and when the user feedback is similar, sets the user feedback similarity as an additional dimension after the primary clustering to perform the secondary clustering. The apparatus 130 for providing a global water data service platform determines the user feedback similarity based on the similarity of purchase reviews included in the user feedback. The apparatus 130 for providing a global water data service platform assigns a relatively high weight on the user feedback similarity, and ensures that the secondary clustering, which takes into account the user response, is strongly performed as the scaling and quantization proceed. The apparatus 130 for providing a global water data service platform generates alternative order data by considering whether continuous orders for other products recommended as alternative orders are made for users who initially select other products when recommending other products as the alternative orders.

The apparatus 130 for providing a global water data service platform sets the dimension of the alternative order data as an additional dimension and ensures that the secondary clustering is strongly performed by considering the alternative order data so that the distance between two products becomes closer as the continuous orders are placed. In other words, the apparatus 130 for providing a global water data service platform may adaptively change candidates of the alternative products that consider the user response and the user order data by performing the secondary clustering through the addition of the dimension after the primary clustering.

As described above, according to the present embodiment, it is possible to collect the detailed information on the global products, select the products with the detailed information matching the input keywords, filter and output the products according to the input filtering conditions, group the data included in the detailed information by associating the data with each other or providing the additional information, and recommend or consult the products based on the detailed information.

The technical idea of the present embodiments has been merely illustratively described hereinabove, and those skilled in the art to which the present embodiments pertain may make various modifications and alterations without departing from the essential characteristics of the present embodiments. Accordingly, the present embodiments are to describe the technical idea of the present embodiments rather than to limit the technical idea of the present embodiments. The scope of the present embodiments is not limited to these embodiments. The scope of the present embodiments should be interpreted by the following claims, and it should be interpreted that all the spirits equivalent to the following claims fall within the scope of the present embodiments.

What is claimed is:

1. An apparatus for providing a global water data service platform, comprising:
a keyword input unit that receives a keyword input by a user's operation or command through a terminal;
a detailed information selection unit that selects product information having detailed information matching a keyword from among a plurality of pieces of product information;
a product filtering unit that filters information corresponding to the keyword among the product information having the detailed information matching the keyword and then outputs final product information;
a product consulting unit that generates and outputs consulting information based on the detailed information corresponding to the final product information;
a product recommendation unit that selects a recommended product based on the detailed information and the consulting information; and
a product promotion information generation unit that generates product promotion information based on the detailed information, the consulting information, and the recommended product.

2. The apparatus of claim 1, wherein the detailed information selection unit selects one or more of production country information, production site information, water source information, manufacturer information, ingredient information, and storytelling information included in the detailed information matching the keyword.

3. The apparatus of claim 1, wherein the product consulting unit extracts storytelling information included in the detailed information and then generates the consulting information based on the storytelling information.

4. The apparatus of claim 1, wherein the product consulting unit extracts product-specific special features based on the detailed information and allows the extracted product-specific special features to be included in the consulting information.

5. The apparatus of claim 1, wherein the product recommendation unit recommends a product corresponding to the keyword based on a value that reflects a weight by category for the keyword.
